(19) United States
(12) Patent Application Publication
(10) Pub. No.: US 2026/0106301 A1
(43) Pub. Date: Apr. 16, 2026

(54) Battery Cell

(71) Applicant: Dr. Ing. h.c. F. Porsche Aktiengesellschaft, Stuttgart (DE)

(72) Inventor: Justus Speichermann, Stuttgart (DE)

(73) Assignee: Dr. Ing. h.c. F. Porsche Aktiengesellschaft, Stuttgart (DE)

(21) Appl. No.: 19/356,395

(22) Filed: Oct. 13, 2025

(30) Foreign Application Priority Data
Oct. 14, 2024 (DE) 102024129676.3

(51) Int. Cl. H01M 50/262; H01M 10/48; H01M 50/105

(52) U.S. Cl. CPC H01M 50/262; H01M 10/486; H01M 50/105

(57) ABSTRACT

A battery cell has an outer shell that encloses an interior space. Battery cell elements are arranged in the interior space. At least one fastening element is fastened to the outer shell, by way of which a temperature sensor is fastened in a form-fitting manner and is thermally connected to the outer shell.

### CROSS-REFERENCE TO RELATED APPLICATION

This application claims priority to German Patent Application No. 10 2024 129 676.3, filed Oct. 14, 2024, the content of such application being incorporated by reference herein in its entirety.

### FIELD OF THE INVENTION

The invention relates to a battery cell, in particular for a motor vehicle battery.

### BACKGROUND OF THE INVENTION

The properties of a battery cell are typically temperature-dependent, so it is important to take the temperature of the battery cell into account when controlling it. Therefore, providing the temperature of the battery cell is of some importance. However, it is problematic to fasten a temperature sensor securely and permanently to the battery cell over the lifetime of the battery cell, because the battery cells are subject to varying thermal expansion due to thermal fluctuations, which can make fastening the temperature sensor a challenge.

Fastening a temperature sensor to a so-called pouch cell, also known as a coffee bag cell, poses particular challenges because the outer shell of the pouch cell is made of a flexible film that does not provide a very stable surface for attaching a temperature sensor.

Temperature sensors may be glued directly onto the surface of the outer shell of the battery cells, which, due to the flexible outer shell of pouch cells, can lead to unreliable fastening and unreliable thermal contact of the respective temperature sensor. If the thermal contact is poorly designed, the temperature sensor might not detect the actual temperature of the battery cell, which is detrimental to the control of the battery cell.

It would be desirable to have a battery cell designed as a pouch cell with secure fastening and thermal contact for a temperature sensor.

### SUMMARY OF THE INVENTION

One exemplary embodiment of the invention relates to a battery cell with an outer shell that encloses an interior space, with battery cell elements arranged in the interior space, wherein at least one fastening element is fastened to the outer shell, by means of which a temperature sensor is fastened in a form-fitting manner and thermally connected to the outer shell. This allows the temperature sensor to be securely fastened, wherein the fastening is still reliable over the service life of the battery cell, even if the battery cell is a pouch cell with an outer shell made of a film material.

It is also advantageous if at least one fastening element is a protruding element or has a protruding element that carries locking elements by means of which the temperature sensor can be locked onto the protruding element. Preferably, the protruding element is made of plastic and the locking elements are designed with a defined flexibility so that the temperature sensor can be attached.

It is also particularly advantageous if the protruding element is designed as a pin with locking lugs, wherein the pin optionally has a tip, in particular a removable tip. The tip can be designed as an insertion aid, which can then be removed if desired.

It is also advantageous if several fastening elements or protruding elements are arranged, which are designed in particular as a pin with locking lugs, wherein the protruding elements are arranged at a distance from each other. This also allows for the secure positioning and fastening of a temperature sensor.

In another example embodiment, it is also advantageous if the temperature sensor is designed with a base plate, in particular on which one or more temperature sensor elements are fastened, wherein the temperature sensor is fastened to the outer shell by means of the base plate by means of the at least one protruding element. This allows the respective temperature sensor element of the temperature sensor to be securely positioned, and the base plate serves as a stable fastening base.

It is also advantageous if the base plate has at least one opening, wherein the fastening element or the protruding element engages through the opening and, by means of the locking elements, engages behind the respective edge of the opening in a form-fitting manner. This provides a simple fastening solution.

It is also advantageous if the base plate has a surrounding edge region, wherein the spaced-apart fastening elements or protruding elements accommodate the base plate between them and the locking elements engage behind the edge region of the base plate in a form-fitting manner. This provides an alternative fastening solution.

It is also advantageous if the temperature sensor is additionally thermally conductively connected and/or bonded to the outer shell by means of a casting compound and/or adhesive, such as foam material in particular. This creates improved thermal coupling, especially if the substrate is uneven or textured, for example.

It is also advantageous if the base plate is perforated. This allows the adhesive, foam, or other sealing compound to be applied through a hole, which is also possible after the temperature sensor has been positioned.

It is particularly preferable if at least one protruding element protrudes from the outer shell in a normal direction. This provides a safe way to place the temperature sensor directly on the outer shell.

### BRIEF DESCRIPTION OF THE DRAWINGS

The invention is described in detail below on the basis of an example embodiment with reference to the drawings. The drawings show:

FIG. 1 is a schematic view of an example embodiment of a battery cell designed as a pouch cell,

FIG. 2 is a sectional view of an exemplary surface of the outer shell of the battery cell,

FIG. 3 is a schematic view of an example embodiment of a temperature sensor,

FIG. 4 is a sectional view of an exemplary surface of the outer shell of the battery cell with a fastening element,

FIG. 5 is a schematic view of another example embodiment of a temperature sensor,

FIG. 6 is a sectional view of an exemplary surface of the outer shell of the battery cell with a temperature sensor fastened by means of a fastening element, and

FIG. 7 is a cross-sectional view of an exemplary surface of the outer shell of the battery cell with a temperature sensor fastened by means of several fastening elements.

### DETAILED DESCRIPTION OF THE INVENTION

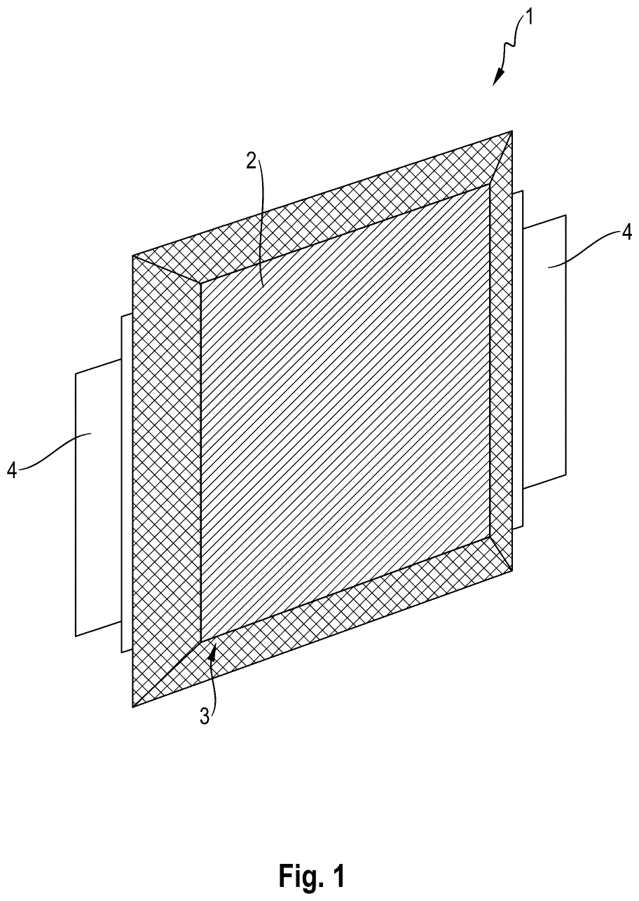

FIG. 1 shows a schematic representation of a battery cell 1, which is designed as a pouch cell, for example. The battery cell 1 has an outer shell 2 made of a film material, which encloses an interior space 3 in which battery cell elements such as electrodes, etc. are arranged. Contact tabs 4 protrude from the side of the outer shell 2, allowing the battery cell 1 to be connected electrically.

The surface of battery cell 1 is typically not very smooth because the outer shell 2 is made of a reinforced film material. Regions of the surface of the outer shell 2 are designed to closely enclose the interior space 3, which is why the battery cell 1 is often evacuated after installation, causing the surface to become uneven in some regions.

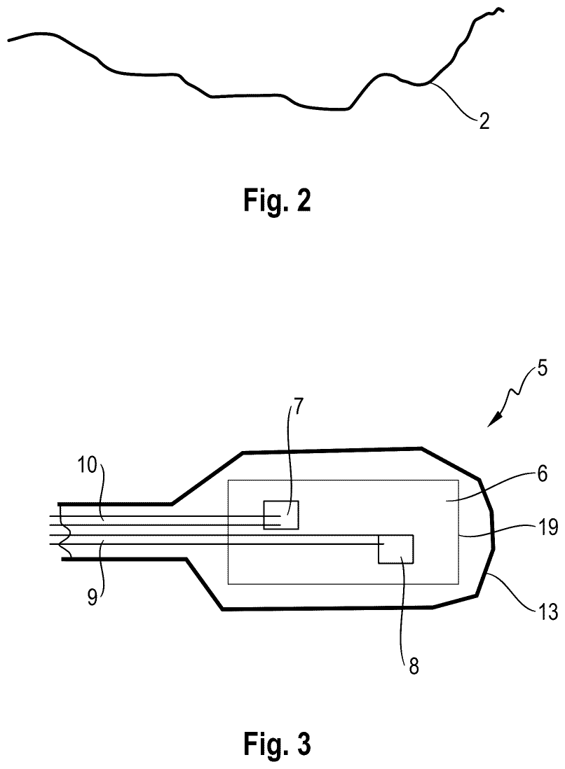

A cross-section of such an uneven outer shell 2 is shown schematically in FIG. 2. You can see the unevenness of the outer shell 2.

FIG. 3 shows a schematic representation of a temperature sensor 5, as it can be fastened, for example, to the outer shell 2 of the battery cell 1. The temperature sensor 5 has a base plate 6 on which a temperature sensor element 7 is fastened or on which several temperature sensor elements 7, 8 are fastened. In the example embodiment shown in FIG. 3, two such temperature sensor elements 7, 8 with respective electrical supply lines 9, 10 are provided to allow redundant temperature measurement. The temperature sensor 5 may also comprise an enclosing shell 13, which can serve to protect the temperature sensor 5.

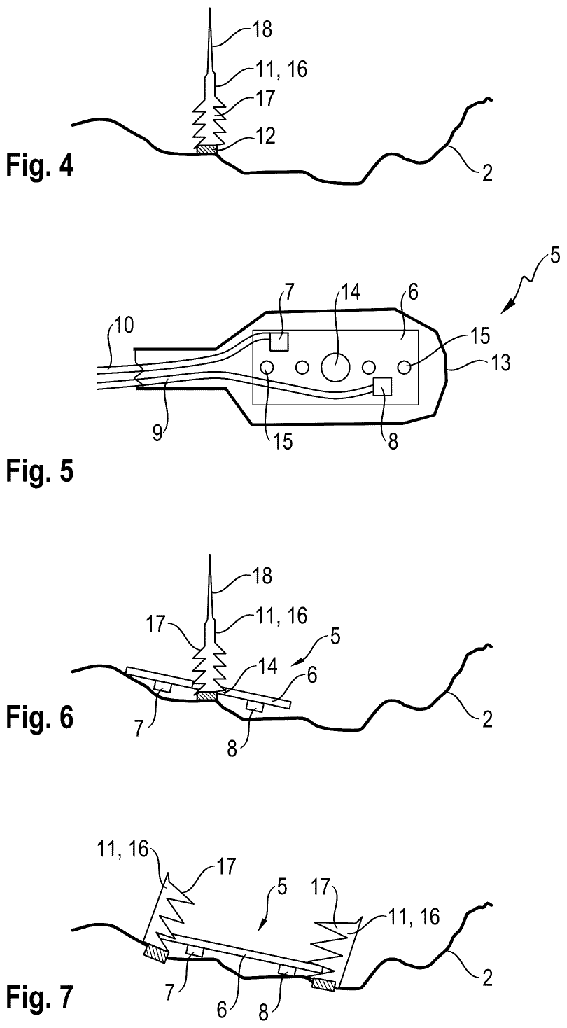

FIG. 4 shows another example embodiment of the arrangement of a fastening element 11 on the outer shell 2 of the battery cell 1. Only one fastening element 11 may be provided, or alternatively, several fastening elements 11 may be provided.

The respective fastening element 11 is, for example, glued to the outer shell 11 using an adhesive 12 or otherwise mechanically fastened.

The fastening element 11 serves to connect the temperature sensor 5 to the outer shell 2. The fastening element 11 and the temperature sensor 5 are such that the temperature sensor 5 can be fastened in a form-fitting manner to the fastening element 11 and can be thermally connected to the outer shell 2 such that it is well thermally connected.

Preferably, at least one fastening element 11 or at least one protruding element 16 protrudes from the outer shell 2 in a normal direction.

FIG. 5 shows a schematic representation of an alternative temperature sensor 5, as it can be fastened to the outer shell 2 of the battery cell 1, for example. The temperature sensor 5 has a perforated base plate 6 on which a temperature sensor element 7 is fastened or on which several temperature sensor elements 7, 8 are fastened. In the example embodiment shown in FIG. 5, two such temperature sensor elements 7, 8 with respective electrical supply lines 9, 10 are provided to allow redundant temperature measurement. The temperature sensor 5 may also comprise an enclosing shell 13, which can serve to protect the temperature sensor 5. The perforation of the base plate 6 is designed such that at least a first hole is provided as an opening 14, which serves to fasten the temperature sensor 5 in a form-fitting manner by means of the fastening element 11. One or more additional holes 15 may be provided to achieve improved thermal connection to the outer shell 2.

FIG. 6 shows how the temperature sensor 5 is fastened to the outer shell 2 by means of the base plate 6 using at least one fastening element 11.

In this case, at least one fastening element 11 is designed as a protruding element 16 or has such a protruding element 16. The protruding element 16 carries locking elements 17, which protrude laterally and by means of which the temperature sensor 5 can be locked onto the protruding element 16.

In the example embodiment shown, the base plate 6 has at least one opening 14, wherein the fastening element 11 or the protruding element 16 engages through the opening 14 and, by means of the locking elements 17, engages behind the edge of the opening 14 in a form-fitting manner, thereby fastening the temperature sensor 5.

FIGS. 4 and 6 show that the protruding element 16 is designed as a pin with locking lugs 17, wherein the pin optionally has a tip 18, in particular a removable tip. The tip 18 serves as an insertion aid for inserting the pin into the hole as opening 14 of the base plate 6. The tip can then also be removed.

FIG. 7 shows another example embodiment in which several fastening elements 11 or protruding elements 16 are arranged, which are designed in particular as a pin having locking elements 17, for example in the form of locking lugs, wherein the protruding elements 16 or the fastening elements 11 are arranged at a distance from one another.

The base plate 6 has a surrounding edge region 19, wherein the spaced-apart fastening elements 11 or protruding elements 16 accommodate the base plate 6 between them and the locking elements 17 engage behind the edge region 19 of the base plate 6 in a form-fitting manner.

In addition, the temperature sensor 5 can also be thermally conductively connected and/or bonded to the outer shell 2 by means of a casting compound and/or adhesive, such as foam material in particular. The perforated base plate can be fastened with this material.

### LIST OF REFERENCE NUMERALS

1 Battery cell
2 Outer shell
3 Interior space
4 Contact tabs
5 Temperature sensor
6 Base plate
7 Temperature sensor element
8 Temperature sensor element
9 Supply lines
10 Supply lines
11 Fastening element
12 Adhesive
13 Shell
14 Opening
15 Hole
16 Element
17 Locking element
18 Tip
19 Edge region

What is claimed is:

1. A battery cell comprising:
an outer shell enclosing an interior space for receiving battery cell elements,
at least one fastening element fastened to the outer shell, and
a temperature sensor fastened in a form-fitting manner onto the outer shell by the at least one fastening element, wherein the temperature sensor is thermally connected to the outer shell.

2. The battery cell according to claim 1, wherein the at least one fastening element comprises a protruding portion and locking elements disposed on the protruding portion for locking the temperature sensor onto the protruding portion.

3. The battery cell according to claim 2, wherein the at least one fastening element is a pin, wherein the pin optionally has a tip.

4. The battery cell according to claim 3, wherein the pin includes the tip and the tip is a removable tip.

5. The battery cell according to claim 1, wherein the at least one fastening element comprises a plurality of fastening elements that are arranged at a distance from one another, which each fastening element is a pin having locking elements.

6. The battery cell according to claim 1, wherein the temperature sensor comprises a base plate and a temperature sensor element fastened to the base plate, wherein the base plate is fastened to the outer shell by way of the at least one fastening element.

7. The battery cell according to claim 1, wherein the at least one fastening element has a protruding portion and locking elements disposed on the protruding portion for locking the temperature sensor onto the protruding portion, wherein the temperature sensor comprises a base plate and a temperature sensor element fastened to the base plate, wherein the base plate is fastened to the outer shell by way of the at least one fastening element, and wherein the base plate has at least one opening, wherein the fastening element engages through the opening and, by way of the locking elements, engages behind an edge of the opening in a form-fitting manner.

8. The battery cell according to claim 1, wherein the at least one fastening element comprises a plurality of fastening elements that are arranged at a distance from one another, which each fastening element is a pin having locking elements, wherein the base plate has a surrounding edge region, wherein the base plate is accommodated between the fastening elements and the locking elements engage behind the edge region of the base plate in a form-fitting manner.

9. The battery cell according to claim 1, wherein the temperature sensor is additionally thermally conductively connected and/or bonded to the outer shell by way of a casting compound and/or adhesive.

10. The battery cell according to claim 9, wherein the adhesive comprises a foam material.

11. The battery cell according to claim 1, wherein the temperature sensor comprises a base plate and a temperature sensor element fastened to the base plate, wherein the base plate is fastened to the outer shell by way of the at least one fastening element, and wherein the base plate is perforated.

12. The battery cell according to claim 1, wherein the at least one fastening element protrudes in a normal direction from the outer shell.
